(19) United States
(12) Patent Application Publication
(10) Pub. No.: US 2012/0173987 A1
(43) Pub. Date: Jul. 5, 2012

(54) SYSTEM FOR ANALYZING INSTANT MESSAGES AND BROWSING BEHAVIOR OF NON-SPECIFIC USERS IN THE CLOUD WEBSITE

(76) Inventor: Yueh Peng HUNG, Taichung City (TW)

(21) Appl. No.: 12/981,838

(22) Filed: Dec. 30, 2010

(51) Int. Cl. G06F 3/00

(52) U.S. Cl. 715/738

(57) ABSTRACT

A system for analyzing instant messages and browsing behavior of non-specific users in the Cloud Website utilizes a control system to be built on a Cloud Network. An embedded monitoring code of the control system connects to a business website system for timely monitoring visitors on the website by means of a total Cloud computing technology. A backstage device, a data-retrieving device, and a database device built on a Cloud system of the control system are served to analyze and record the position, the browsing content, the stay time, the searching keyword, and the browsing history of the visitors. A written communication module, an F.M.S. instant video stream module, and a telecommunication module built in a communicating unit of the backstage device are served to timely contact the visitors with an instant video or a short message. Thus, the tendencies and the needs of the users on the website could be well-controlled, so that a person in charge of the website provides an efficient service since the present invention preferably supports the management thereof.

### BACKGROUND OF THE INVENTION

1. Field of the Invention

The present invention relates to a system for analyzing the instant message and the browsing behavior of non-specific users in the Cloud Website, which is especially applied to a service and manage system directed to non-specific users through a total Cloud computing technology.

2. Description of the Related Art

In the Internet service, the modes for management and marketing are actually passive. Namely, users may link to any website through the search engine or by clicking the keyword advertisement. Herein, the website might be provided and paid by the person in charge of the website with a very high price in order to raise the pagerank, the click-through rate, and the number of clients. Additionally, the functions, services, and information provided on the website are all provided by the correspondent administrator of a company, and in fact, the administrator can merely serve limited clients that send messages or e-mails to the website. Thus, for the administrator, the behavior of the users are actually difficult to control. Moreover, other shortcomings are as follows:

1. Difficult in control: in view of the passive management on the website, the administrator of the website can merely provide his service by the client sending messages to the website while the client notices the administrator's keyword advertisement and then clicks it on the search engine. Obviously, the administrator cannot directly and timely communicate with his client online; not even mention that the administrator cannot opportunely link to the client's IP by cellphone or telephone. Thus, the control over the possible client for the administrator is in fact difficult.

2. Incomplete marketing service: there are too many functions, services, and pieces of information for the administrator to control at a time since the website is actually passively managed. Moreover, the administrator can only provide services while the client sending questions or messages to the website. Therefore, the administrator cannot actively control the information of all clients, record the browsing behavior of the visitors, or analyze and be in charge of the possible customers. Obviously, the service provided by the administrator is unsatisfactory.

Accordingly, the present invention of a system for analyzing instant messages and browsing behavior of non-specific users in the Cloud Website is to solve the shortcomings in the existing technology.

### SUMMARY OF THE INVENTION

The object of the present invention is to provide a system for analyzing instant messages and browsing behavior of non-specific users in the Cloud Website. Wherein, a service interface and a control system are combined through a two-way connection. The control system is combined with a business website system through a two-way connection. Further, a business computer and a business communication facility of the service interface are respectively combined with a controlling backstage of the business website through a two-way connection. The controlling backstage of the business website is combined with the embedded monitoring code through a two-way connection. A plurality of visitor units of a user system are connected to the business website system through a Cloud Network. The control system is built on the Cloud Network, and the embedded monitoring code of the control system is combined with the business website system for timely monitoring the information of the visitors through the total Cloud computing technology. The position, the browsing content, the stay time, the searching keyword, and the browsing history can be all analyzed and recorded by means of a Cloud system building a backstage device, a data-retrieving device, and a database device. Thereby, an active instant video or instant message could be timely sent to the administrator through a written communication module, an F.M.S. instant video stream module, and a telecommunication module of a communicating unit of the backstage device. As a result, the messages that show the movements and needs of the clients could be timely provided and controlled, so that a superior service could be offered with a satisfactory management and a complete assistance.

### DESCRIPTION OF ELEMENTS IN THE DRAWINGS

10 service interface
11 business computer
12 business communication facility
20 control system
21 Cloud system
210 backstage device
210A managing unit
210A-1 ID-managing module
210A-2 archive-managing module
210A-3 online rings module
210A-4 label-and-color-managing module
210B visitor-analysis unit
210B-1 IP positioning module
210B-2 browse-history-analysis module
210B-3 source-analysis module
210B-4 visiting time and visiting frequency calculating module
210B-5 visitor's keyword analysis module
210C communicating unit
210C-1 written communication module
210C-2 F.M.S. instant video stream module
210C-3 telecommunication module
211 data-retrieving device
212 database device
212A can message module
212B Q&A database module
212C conversation database module
212D browsing history database module
212E Smileys database module
22 embedded monitoring code
30 business website system
31 controlling backstage of the business website
32 business website unit
40 Cloud Network
50 user system
51 visitor unit

### BRIEF DESCRIPTION OF THE DRAWINGS

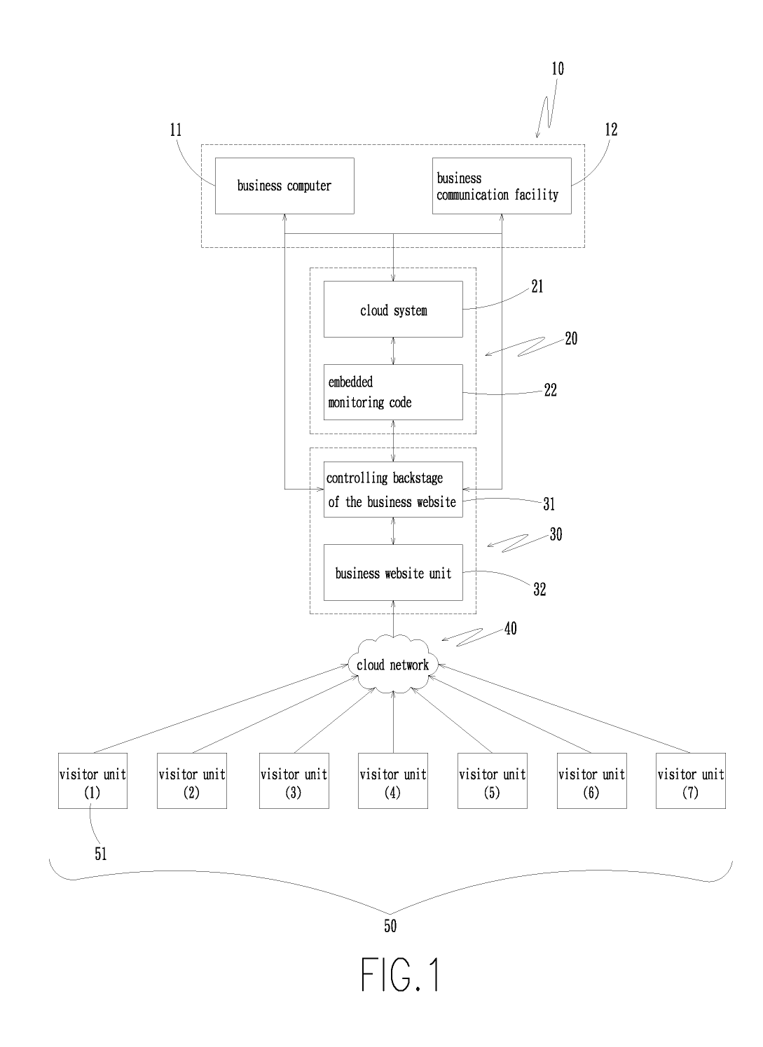

FIG. 1 is a schematic view of the present invention;

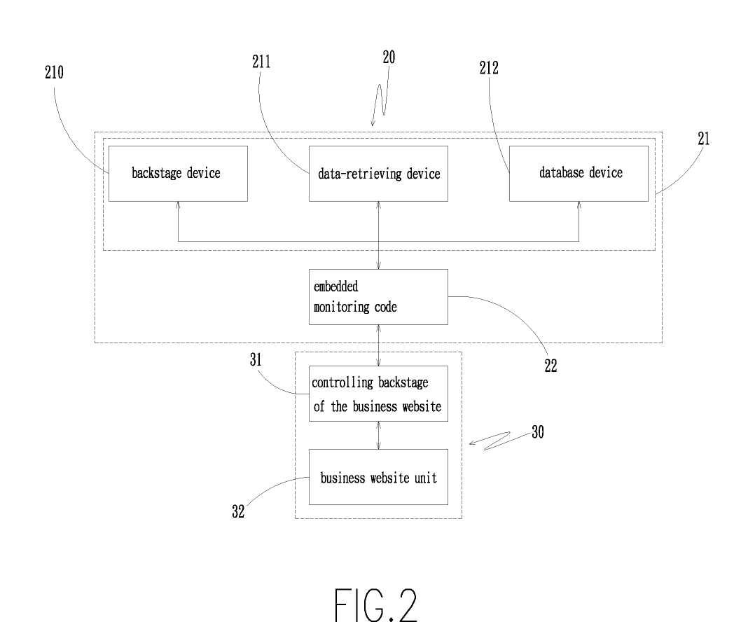

FIG. 2 is a schematic view showing a Cloud system of the present invention;

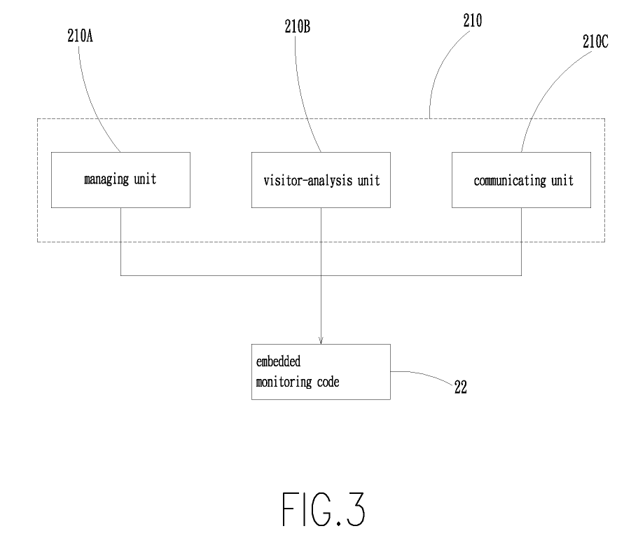

FIG. 3 is a schematic view showing a backstage of the present invention;

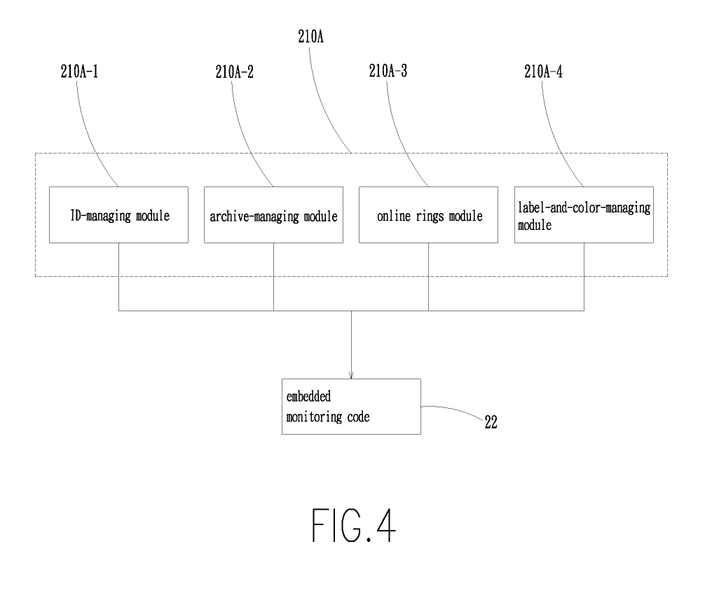

FIG. 4 is a schematic view showing a managing unit of the present invention;

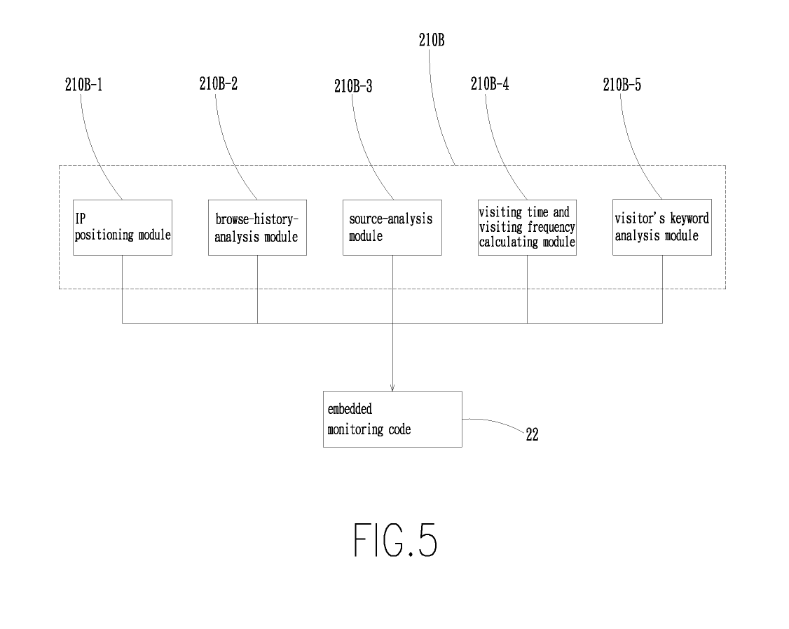

FIG. 5 is a schematic view showing a visitor-analysis unit of the present invention;

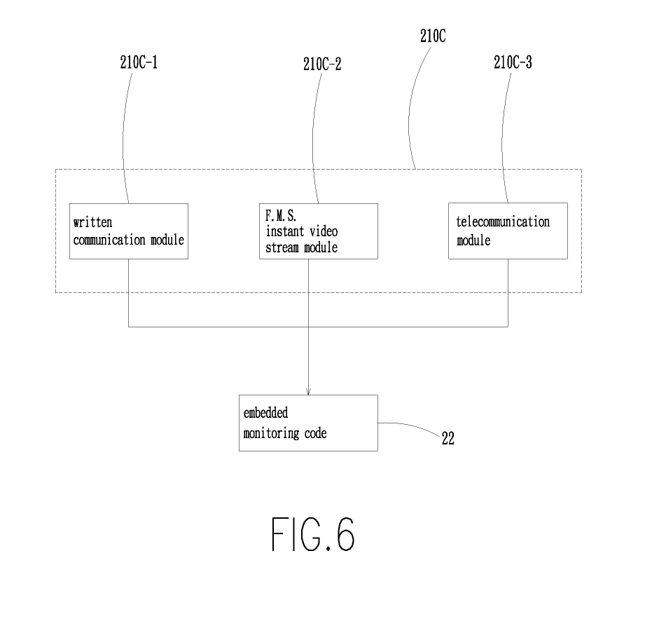

FIG. 6 is a schematic view showing a communicating unit of the present invention; and

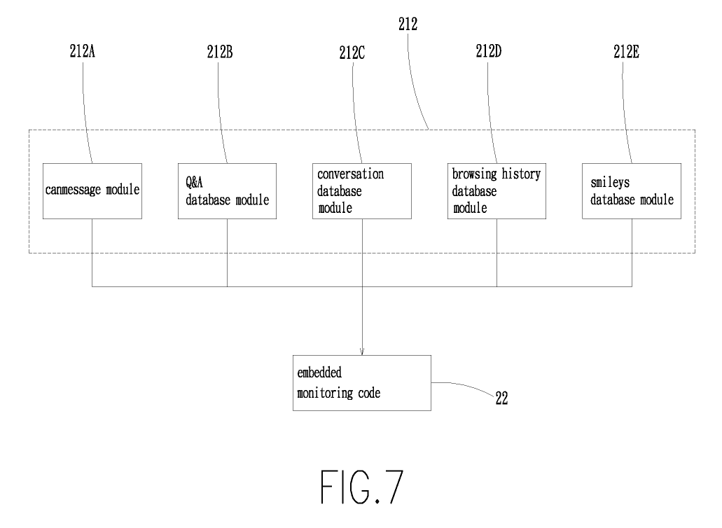

FIG. 7 is a schematic view showing a database device of the present invention.

### DETAILED DESCRIPTION OF THE PREFERRED EMBODIMENTS

Following embodiments and correlated drawings do not limit the claimed scope of the present invention but provide a favorable description for building the present invention.

FIGS. 1 to 7 show the present invention of a system for analyzing instant messages and browsing behavior of non-specific users in the Cloud Website. The system includes:

a service interface 10 that includes at least one business computer 11 and at least one business communication facility 12;

a control system 20 that includes a Cloud system 21 and an embedded monitoring code 22; the Cloud system 21 includes a backstage device 210, a data-retrieving device 211, and a database device 212; the backstage device 210 includes a managing unit 210A, a visitor-analysis unit 210B, and a communicating unit 210C; the database device 212 includes a canmessage module 212A, a Q&A database module 212B, a conversation database module 212C, a browsing history database module 212D, and a Smileys database module 212E; the managing unit 210A includes an ID-managing module 210A-1, an archive-managing module 210A-2, an online rings module 210A-3, and a label-and-color-managing module 210A-4; the visitor-analysis unit 210B includes an IP positioning module 210B-1, a browse-history-analysis module 210B-2, a source-analysis module 210B-3, a visiting time and visiting frequency calculating module 210B-4, and a visitor's keyword analysis module 210B-5; the communicating unit 210C includes a written communication module 210C-1, an F.M.S. instant video stream module 210C-2, and a telecommunication module 210C-3; the control system 20 is combined with the service interface 10 through a two-way connection; the Cloud system 21 and the embedded monitoring code 22 are in a two-way connection.

a business website system 30 that includes a controlling backstage 31 of the business website and a business website unit 32; the business website system 30 is combined with a control system 20 through a two-way connection; the controlling backstage 31 of the business website is respectively combined with the business computer 11 and the business communication facility 12 of the service interface 10 through a two-way connection; the controlling backstage 31 of the business website is further combined with the embedded monitoring code 22 of the control system 20 through a two-way connection;

a Cloud Network 40 whose one end is connected to the business website system 30; and

a user system 50 that includes a plurality of visitor units 51; the visitor units 51 are connected to the business website unit 32 of the business website system 30 through the Cloud Network 40.

The present invention of the system for analyzing the instant messages and the browsing behavior of non-specific users in the Cloud Website is achieved by cooperating abovementioned structures.

Referring to FIGS. 1, 2, and 7, the present invention utilizes the service interface 10 and the control system 20 to be combined through the two-way connection. The control system 20 is combined with the business website system 30 through the two-way connection. Further, the business computer 11 and the business communication facility 12 of the service interface 10 are respectively combined with the controlling backstage 31 of the business website through the two-way connection. The controlling backstage 31 of the business website is combined with the embedded monitoring code 22 of the control system 20 through the two-way connection. A plurality of visitor units 51 of the user system 50 are connected to the business website system 30 through the Cloud Network 40. The control system 20 is built on the Cloud Network 40, and the embedded monitoring code 22 of the control system 20 is combined with the business website system 30 for timely monitoring the information of the visitors through the total Cloud computing technology. The position, the browsing content, the stay time, the searching keyword, and the browsing history can be all analyzed and recorded by means of the Cloud system 21 of the control system 20 building a backstage device 210, a data-retrieving device 211, and a database device 212. Thereby, an active or passive instant video or instant message could be timely sent to the administrator through the written communication module 210C-1, the F.M.S. instant video stream module 210C-2, and the telecommunication module 210C-3 of the communicating unit 210C of the backstage device 210. As a result, the administrator is able to timely contact his client through cellphone or telephone. Thereby, the messages that show the movements and needs of the clients could be timely provided and controlled, so that a superior service could be offered with a satisfactory management and a complete assistance.

Referring to FIGS. 2 to 4, the present invention utilizes the embedded monitoring code 22 to connect to the business website system 30. The embedded monitoring code 22 further connects to the backstage device 210. Preferably, the managing unit 210A of the backstage device 210 marks the users that just login or surf the business website system 30 through the cooperation of the ID-managing module 210A-1, the archive-managing module 210A-2, the online rings module 210A-3, and the label-and-color-managing module 210A-4. Alternatively, the managing unit 210A could timely record and analyze the IDs retrieved from the login data of the users by the cooperation of the ID-managing module 210A-1 and the archive-managing module 210A-2. Thereby, the online rings module 210A-3 would set divergent audios for the non-specific users and the specific users. As to the label-and-color-managing module 210A-4, the non-specific users and the specific users logining the website would be marked with different colors. Accordingly, the administrator is able to trace the behavior of the users that login the business website system 30.

Referring to FIGS. 2, 3, and 5, the present invention still utilizes the embedded monitoring code 22 to connect to the business website system 30. The embedded monitoring code 22 further connects to the backstage device 210. The visitor-analysis unit 210B preferably analyzes and calculates the users that login or browse the business website system through the IP positioning module 210B-1, the browse-history-analysis module 210B-2, the source-analysis module 210B-3, the visiting time and visiting frequency calculating module 210B-4, and the visitor' s keyword analysis module 210B-5. That is, the visitor-analysis unit 210B positions and records the IP address of the user through the IP positioning module 210B-1. Thereby, individual analysis and independent calculation for the respective user that logins or browses the business website system 30 could be executed through the browse-history-analysis module 210B-2, the source-analysis module 210B-3, the visiting time and visiting frequency calculating module 210B-4, and the visitor's keyword analysis module 210B-5. As a result, the motivation of the user who logins or browses the business website system 30 could be effectively controlled and analyzes.

Referring to FIGS. 2, 3, and 6, the present invention still utilizes the embedded monitoring code 22 to connect to the business website system 30. The embedded monitoring code 22 further connects to the backstage device 210. The communicating unit 210C of the backstage device 210 links to the user who logins or browses the business website system for achieving the written communication, the audio communication, and the video communication by means of the cooperation of the written communication module 210C-1, the F.M.S. instant video stream module 210C-2, and the telecommunication module 210C-3. The communicating unit 210C further transforms the messages or e-mails that are sent to the business computer 11 and the business communication facility 12 of the service interface 10 into short messages. Thereby, the communicating unit 210C resends the short messages back to the backstage device 210. Accordingly, the backstage device 210 sends the short messages to the service interface 10. The telecommunication module 210C-3 further includes a control code that assists the administrator in linking to the IP address of the user by means of the cellphone. Thereby, the administrator is able to actively communicate with the user who logins or browses the business website system 30, or the administrator is capable of directly replying to the problems raised by the online user.

Referring to FIGS. 2 and 7, the present invention still utilizes the embedded monitoring code 22 to connect to the business website system 30. The embedded monitoring code 22 further connects to the backstage device 210. The database device 212 searches any possible replies that were recorded in the canmessage module 212A, in the Q&A database module 212B, the conversation database module 212C, and the Smileys database module 212E. Accordingly, the database device 212 is able to actively reply the problems raised by the users. If the database device 212 searches no correlated replies recorded, the browsing history database module 212D timely records said questions and browsing history information of the users and succeedingly sends the information to the communicating unit 210C of the backstage device 210, so that the database device 212 instantly communicates with the users and replies to the questions online.

Advantages of the present invention are as follows:

1. Good at control: The active communication, the timely message transmission, and the direct response could be brought about by the written communication module, the F.M.S. instant video stream module, and the telecommunication module. Moreover, the administrator could contact the users through the cellphone and the telephone so as to preferably know their tendencies and needs well. Therefore, an easy control could be achieved.

2. Complete marketing service: The control system is preferably set on the Clout Network, and the embedded monitoring code of the control system is connected to the business website system. Thereby, users who visit the website could be timely monitored by means of the total Cloud computing technology. Additionally, the position of the user, the web content of the user, the stay time of the user on the webpage, the searching keyword of the user, the browsing history of the user are all to be analyzed and recorded by means of the cooperation of the backstage device, the data-retrieving device, and the database device of the Cloud system of the control system. Thus, a timely and active service could be provided by the administrator since the tendencies and the needs of the user are all well-controlled. Accordingly, a satisfactory service is offered.

Afore preferred embodiments have shown the patentability of the present invention, and thereby the applicant applies for a patent application accordingly.

I claim:

1. A system for analyzing instant messages and browsing behavior of non-specific users in the Cloud Website comprising: a control system that includes a Cloud system and an embedded monitoring code; said Cloud system including a backstage device, a data-retrieving device, and a database device; said backstage device including a managing unit, a visitor-analysis unit, and a communicating unit; said database device including a conversation database module and a browsing history database module; the managing unit including an ID-managing module and an archive-managing module; said visitor-analysis unit including an IP positioning module, a browse-history-analysis module, a source-analysis module, a visiting time and visiting frequency calculating module, and a visitor's keyword analysis module; said communicating unit including a written communication module, an F.M.S. instant video stream module, and a telecommunication module; said Cloud system and said embedded monitoring code being in a two-way connection.

2. The system as claimed in claim 1, wherein, said database device includes a canmessage module, a Q&A database module, and a Smileys database module.

3. The system as claimed in claim 1 or 2, wherein, said embedded monitoring code is connected to said database device; said database device searches correlated replies recorded in said canmessage module, said Q&A database module, said conversation database module, and said Smileys database module according to questions raised by users who login in or surf a business website system, whereby said database device actively replies to said questions raised by said users accordingly; if said database device searches no correlated replies recorded, said browsing history database module timely records said questions and browsing history information of said users and succeedingly sends said information to said communicating unit of said backstage device, so that said database device instantly communicates with said users and replies to said questions online

4. The system as claimed in claim 1, wherein, said managing unit includes an online rings module and a label-and-color-managing module.

5. The system as claimed in claim 1 or 4, wherein, said managing unit of said backstage device marks said users who login or surf said business website system via an ID-managing module, an archive-managing module, said online rings module, and said label-and-color-managing module; data like IDs of said logining users are recorded and analyzed by said ID-managing module and said archive-managing module;
said online rings module further sets an online ring for said logining user who is originally a non-specific user but afterward becomes a specific user and provides a reminding of an online sound for both said non-specific user and said specific user; said label-and-color-managing module marks said logining user who is non-specific by divergent labels and colors.

6. The system as claimed in claim 1, wherein, said visitor-analysis unit of said backstage device utilizes said IP positioning module, said browse-history-analysis module, said source-analysis module, said visiting time and visiting frequency calculating module, and said visitor's keyword analysis module to analyze and calculate said users that login or surf said business website system; said IP positioning module positions and records an IP address of said login user; said browse-history-analysis module, said source-analysis module, said visiting time and visiting frequency calculating module, and said visitor's keyword analysis module analyzes and calculates each of said users that logins or surfs said business website system.

7. The system as claimed in claim 1, wherein, said communicating unit of said backstage device utilizes said written communication module, said F.M.S. instant video stream module, and said telecommunication module to instantly communicate with users who login and surf said business website system by a written form, a speech form, or a video form; said written communication module transforms messages or emails that are sent to a business computer and a business communicatino facility on a service interface into short messages; said short messages are transmitted back to said backstage device via said communicating unit and thence sent to said service interface via said backstage device; a controlling code is set in said telecommunication module for connecting to said IP address of said user's computer via a mobile device, whereby a business party is able to actively and instantly contact said user that logins and surfs said business website system for a mutual communication and a timely inquiry.

8. A system for analyzing the instant message and the browsing behavior of non-specific users in the Cloud Website comprising:
a service interface that includes at least one business computer and at least one business communication facility;
a control system that includes a Cloud system and an embedded monitoring code; said Cloud system including a backstage device, a data-retrieving device, and a database device; said backstage device including a managing unit, a visitor-analysis unit, and a communicating unit; said database device including a conversation database module and a browsing history database module; the managing unit including an ID-managing module and an archive-managing module; said visitor-analysis unit including an IP positioning module, a browse-history-analysis module, a source-analysis module, a visiting time and visiting frequency calculating module, and a visitor's keyword analysis module; said communicating unit including a written communication module, an F.M.S. instant video stream module, and a telecommunication module; said Cloud system and said embedded monitoring code being in a two-way connection.
a business website system that includes a controlling backstage of said business website and a business website unit; said business website system and said control system being in a two-way connection; said controlling backstage of the business website being in a two-way communication with said business computer and said business communication facility of said service interface, respectively; said controlling backstage of the business website being further combined with said embedded monitoring code of said control system through a two-way connection;
a Cloud Network provided with one end thereof connected to said business website system; and
a user system that includes a plurality of visitor units; said visitor units being connected to said business website unit of said business website system through said Cloud Network.

9. The system as claimed in claim 8, wherein, said database device includes a canmessage module, a Q&A database module, and a Smileys database module.

10. The system as claimed in claim 8 or 9, wherein, said embedded monitoring code is connected to the database device; said database device searches correlated replies recorded in said canmessage module, said Q&A database module, said conversation database module, and said Smileys database module according to questions raised by users who login in or surf a business website system; thereby, said database device actively replies to said questions raised by said users accordingly; if said database device searches no correlated replies recorded, said browsing history database module timely records said questions and browsing history information of said users and succeedingly sends said information to said communicating unit of said backstage device, so that said database device instantly communicates with said users and replies to said questions online.

11. The system as claimed in claim 8, wherein, said managing unit includes an online rings module and a label-and-color-managing module.

12. The system as claimed in claim 8 or 11, wherein, said managing unit of said backstage device marks said users who login or surf said business website system via an ID-managing module, an archive-managing module, said online rings module, and said label-and-color-managing module; data like IDs of said logining users are recorded and analyzed by said ID-managing module and said archive-managing module; said online rings module further sets an online ring for said logining user who is originally a non-specific user but afterward becomes a specific user and provides a reminding of an online sound for both said non-specific user and said specific user; said label-and-color-managing module marks said logining user who is non-specific by divergent labels and colors.

13. The system as claimed in claim 8, wherein, said visitor-analysis unit of said backstage device utilizes said IP positioning module, said browse-history-analysis module, said source-analysis module, said visiting time and visiting frequency calculating module, and said visitor's keyword analysis module to analyze and calculate said users that login or surf said business website system; said IP positioning module positions and records an IP address of said login user; said browse-history-analysis module, said source-analysis module, said visiting time and visiting frequency calculating module, and said visitor's keyword analysis module analyzes and calculates each of users that logins or surfs said business website system.

14. The system as claimed in claim 8, wherein, said communicating unit of said backstage device utilizes said written communication module, said F.M.S. instant video stream module, and said telecommunication module to instantly communicate with users who login and surf said business website by a written form, a speech form, or a video form; said written communication module transforms messages or emails that are sent to a business computer and a business communicatino facility on a service interface into short messages; said short messages are transmitted back to said backstage device via said communicating unit and thence sent to said service interface via said backstage device; a controlling code is set in said telecommunication module for connecting to said IP address of said user's computer via a mobile device, whereby a business party is able to actively and instantly contact said user that logins and surfs said business website system for a mutual communication and a timely inquiry.
